(19) United States
(12) Patent Application Publication
(10) Pub. No.: US 2009/0261182 A1
(43) Pub. Date: Oct. 22, 2009

(54) LIQUID DISPENSING APPARATUS

(75) Inventor: Terence Bolton, Surrey (GB)

Correspondence Address: BLANK ROME LLP, WATERGATE, 600 NEW HAMPSHIRE AVENUE, N.W., WASHINGTON, DC, 20037, US

(73) Assignee: Laja Materials Ltd., Isle of Man (GB)

(21) Appl. No.: 12/300,945

(22) PCT Filed: May 17, 2007
(86) PCT No.: PCT/GB07/01852

§ 371 Date: May 8, 2009

(30) Foreign Application Priority Data
May 17, 2006 (GB) 0609685.3

(51) Int. Cl. B05B 11/06; B05B 7/24

(52) U.S. Cl. 239/346; 239/363; 239/418

(57) ABSTRACT

An airbrush having a nozzle through which gas can flow, the end of the nozzle having an inclined surface. The apparatus also includes support means for a liquid source which, in use, is directed towards the inclined surface of the nozzle.

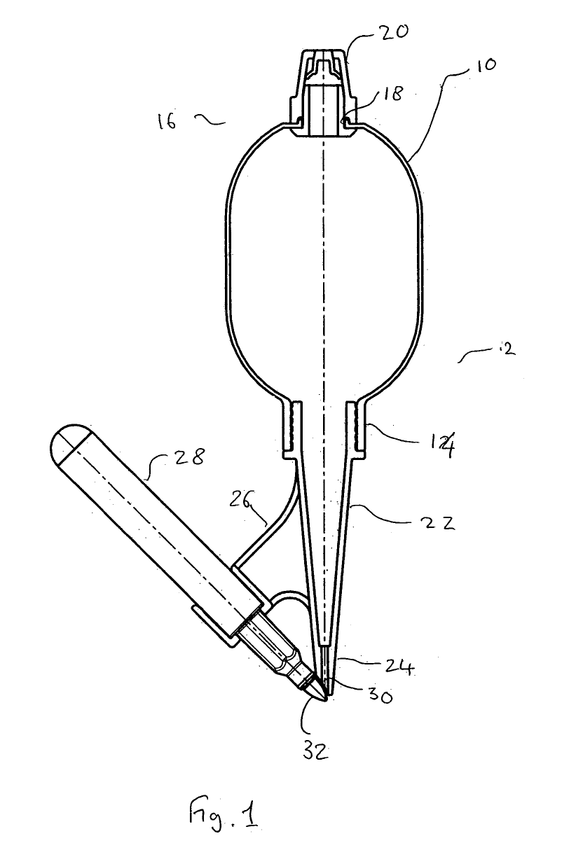

This invention relates to apparatus for dispensing a fine spray of liquid particles and more especially, but not exclusively, to liquid dispensers known as airbrushes.

GB Patent No. 2273065 describes a hand operated pump which can be connected to a liquid dispensing apparatus with the purpose of supplying air under pressure to a liquid source such as a pen with a nib of absorbent material. The hand pump described in that patent is suitable for use with various forms of liquid dispensing apparatus.

The hand operated pump described in GB 2273065 comprises a bulb of flexible material formed with an open ended neck which locates over the inlet end of the liquid dispensing apparatus. Air enters the bulb via a nozzle in the liquid dispensing apparatus. When the liquid source has been positioned adjacent the nozzle, the flexible bulb is squeezed and the air pushed out onto and over the liquid source directed by the nozzle. When the bulb is released, air is again drawn up through the nozzle of the liquid dispensing apparatus and into the bulb.

An improvement to the pump of GB2273065 is described in GB2357809. In this arrangement, a separate air Inlet is provided. This prevents ink being drawn in back through the nozzle, which may otherwise cause large globules of liquid to be dispensed onto the user's substrate.

A disadvantage of the pumps described in GB2357809 is that a relatively high pressure is required in order to obtain sufficient air flow through the nozzle and over the nib to give the desired effect on the apparatus in use. Consequently, the minimum size of the hand-pump is limited which can prevent effective use of the apparatus by young children whose hands are too small to be able to hold and squeeze the hand-pump with sufficient force to provide suitable airflow over the nib. Furthermore, the limitation in the minimum size of the hand-pump provides an apparatus that can appear ungainly and impractical to some potential users.

These problems are alleviated by the provision of a nozzle with an angled opening in accordance with the present invention.

In accordance with one aspect of the present invention, there is provided an airbrush apparatus comprising a nozzle, one end of the nozzle having an aperture, and the other end of the nozzle having attached thereto means for providing flow of gas through the nozzle and out of the aperture, the apertured end of the nozzle having an inclined surface with respect to the longitudinal axis of the nozzle, the apparatus further comprising support means for releasably holding a liquid source such as a felt-tipped pen, one end of the liquid source, in use, being directed towards the inclined surface of the nozzle.

Preferably, the means of providing flow of gas comprises a hand-operated flexible bulb.

Preferably, the felt-tipped pen is held by the support means such that, in use, the longitudinal axis of the nib of the pen lies generally parallel to the inclined surface of the nozzle.

One embodiment of the present invention will now be described, by way of example, with reference to the accompanying Figure, which shows a hand operated flexible bulb according to the present invention.

As can be seen from the Figure, the bulb 10 comprises a continuous surface of flexible rubber. To one end 12, the bulb 10 has an open-ended neck 14. The other end 16 of the bulb 10 has an aperture 18 which receives an attachment 20 suitably configured to fit within the aperture 18 in an airtight manner. The attachment 20 provides means to connect a further air pump, such as a mechanical or electrical pump (not shown) to the end 16 of the bulb 10,

In a further embodiment (not shown) the bulb does not have an aperture to receive any further attachment.

The neck 14 of the bulb 10 is connected to a first conical nozzle 22. A second nozzle 24 overlaps the end of the first nozzle 22.

The outer surface of the first nozzle 22 has a supporting structure 26 attached thereto that supports and retains a pen 28, such as for example a felt-tipped pen. Alternatively the pen 28 may comprise a cartridge containing a technical drawing pen, the nib of a conventional pen or a pen like cylindrical container Including for example, a dip tube through which a colourant such as ink can be withdrawn. Alternatively, edible food colourants, ink based acrylics and emulsified paints may be dispensed by means of the apparatus. A selection of supporting structures 26 may be provided to enable a variety of different liquid sources to be employed.

The supporting structure 26 may, of course, be attached to the outer surface of the first nozzle 22.

The longitudinal axis of the pen 28 is directed and angled towards the apertured end of the second nozzle 24.

The apertured end of the second nozzle 24 is formed with an incline 30 at an angle of between 20 and 60 degrees to the longitudinal axis of the nozzle 24. Preferably the angle of incline is between 40 and 50 degrees. Preferably still, the angle of incline is 45 degrees.

The angle of the incline 30 is designed to correspond with the angle of a nib 32 of the pen 28 when the pen 28 is held within the supporting structure 26 during use. At this time, the slope of the incline 30 is generally perpendicular to the direction of a majority part of the nib 32. In the figure, where the nib 32 is shown to be bullet-shaped, the tip of the nib 32 angles away from the nozzle 24 to form a point. However, the main part of the exposed surface of the nib 32 is held generally parallel to the slope of the incline.

During use air is directed through the apparatus, out of the nozzle 24 and Into the exposed side surface of the nib 32. Expansion of the air occurs right at the tip of the nib 32 forming a fine spray.

The apertured end of the nozzle 24 with an incline 30 to increase the air flow through the nozzle and over the nib 32 during use. Consequently air can be directed through the apparatus at a lower pressure, which allows the size of the bulb 10 to be substantially reduced and hence more appealing and practical for use by a young child.

Furthermore, low pressure automatic air pumps, such as electrical pumps can be used to provide air flow through the device.

In a further embodiment (not shown) the bulb 10 is replaced by a straw which can be blown through to provide the air flow. The inclination 30 of the apertured end of the nozzle 24 provides sufficient air flow over the nib 32 to enable an effective result, even If a simple straw where to be used.

It will be appreciated that the foregoing is merely exemplary of one embodiment of the pump according to the present invention and of just one form of liquid dispensing apparatus with which it may be used. The skilled reader will understand that modifications can readily be made thereto without departing from the true scope of the invention.

1-4. (canceled)

5. A hand held apparatus for producing a spray pattern from a pen or pen-like liquid dispensing device without the intervention of a power source other than a human operator, the apparatus comprising
a frame containing an air nozzle and a pen holder disposed with its axis inclined to the axis of the air nozzle; and
a substantially rigid connecting portion for holding the air nozzle and the pen holder at a fixed angular separation,
the nozzle having a first wider end adapted to permit the direction of air by a human operator through the nozzle, and a second narrower end through which air is directed over the nib of a pen or pen-like liquid dispensing device received in the pen holder, the send end being truncated at an angle which is substantially similar to the angle subtended by the axis of the pen holder to the axis of the nozzle providing a space into which, in use, the nib of the pen is received.

6. An apparatus as claimed in claim 5, wherein the second end is truncated at an angle of between 20 and 60 degrees to the axis of the nozzle.

7. An apparatus as claimed in claim 5, wherein the second end is truncated at an angle of between 40 and 50 degrees to the axis of the nozzle.

8. An apparatus as claimed in claim 5, wherein the second end is truncated at an angle of 45 degrees to the axis of the nozzle.

9. An apparatus as claimed in claim 5, further comprising a hand operated, flexible bulb sealably connected to the first end of the nozzle by means of which air under pressure an be directed through the nozzle.

10. An apparatus as claimed in claim 5, further comprising a mouthpiece and conduit connected to the first end of the nozzle by means of which air can be blown by the operator through the nozzle.

11. An assembly comprising the apparatus of claim 5; and
a pen or pen-like liquid dispensing device.

12. An assembly as claimed in claim 11, wherein the pen or pen-like liquid dispensing device is a felt tipped pen.

13. An apparatus as claimed in claim 11, wherein the pen or pen-like liquid dispensing device is configured to dispense an edible food colorant.
